(19) United States
(12) Patent Application Publication
(10) Pub. No.: US 2025/0211266 A1
(43) Pub. Date: Jun. 26, 2025

(54) METHOD AND APPARATUS FOR REDUCING COMPLEXITY OF DIGITAL PRE-DISTORTION MODEL

(71) Applicant: Intel Corporation, Santa Clara, CA (US)

(72) Inventor: Zoran ZIVKOVIC, Hertogenbosch (NL)

(21) Appl. No.: 18/391,711

(22) Filed: Dec. 21, 2023

(51) Int. Cl. H04B 1/04

(52) U.S. Cl. CPC H04B 1/0475

(57) ABSTRACT

A method and apparatus for reducing complexity of a digital pre-distortion (DPD) model for a non-linear system. DPD circuitry applies a pre-distortion function to input samples to generate pre-distorted samples. The pre-distortion function is represented by a sum of a plurality of terms, and each term is a function of one or more input samples. An optimization process is performed to determine a subset of the terms and a subset of input samples for each term. An optimization function is solved iteratively to find parameters of the pre-distortion function that minimize the optimization function. Each term of the pre-distortion function may be multiplied with a multiplier factor with a constraint that the terms have a unit norm. Alternatively, the subset of input samples may be selected for each term by filtering the input samples with a filter with a constraint that coefficients of the filer have a unit norm.

### BACKGROUND

Digital pre-distortion (DPD) is an effective scheme to linearize a non-linear system, such as a power amplifier (PA). Nowadays, adaptive DPD is commonly used for non-linear systems. Most DPD models used for digital pre-distortions are non-linear models of a certain history of the input signal to revert the non-linear memory effects of the non-linear system. The complexity of such non-linear models can be very large if large memory effects need to be corrected. General models need to consider all the possible interactions of the input signal with its delayed versions. Therefore, it becomes computationally extensive. Reducing the DPD model compute complexity while still keeping a good performance is an important issue.

### BRIEF DESCRIPTION OF THE FIGURES

Some examples of apparatuses and/or methods will be described in the following by way of example only, and with reference to the accompanying figures, in which

FIG. 1 shows a non-linear system;

FIG. 2 shows an example system including DPD circuitry in front of a non-linear system for linearizing the non-linear system;

FIG. 3 shows an example DPD system for a power amplifier;

FIG. 4 is a schematic diagram of an example DPD circuitry;

FIG. 5 is a schematic diagram of an example DPD circuitry using the weighted terms extension;

FIG. 6 is a schematic diagram of an example DPD circuitry using finite impulse response (FIR) filters for selecting the input samples for the terms;

FIG. 7 is a flow diagram of an example process for reducing complexity of DPD model for a non-linear system;

FIG. 8 illustrates a user device in which the examples disclosed herein may be implemented; and

FIG. 9 illustrates a base station or infrastructure equipment radio head in which the examples disclosed herein may be implemented.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

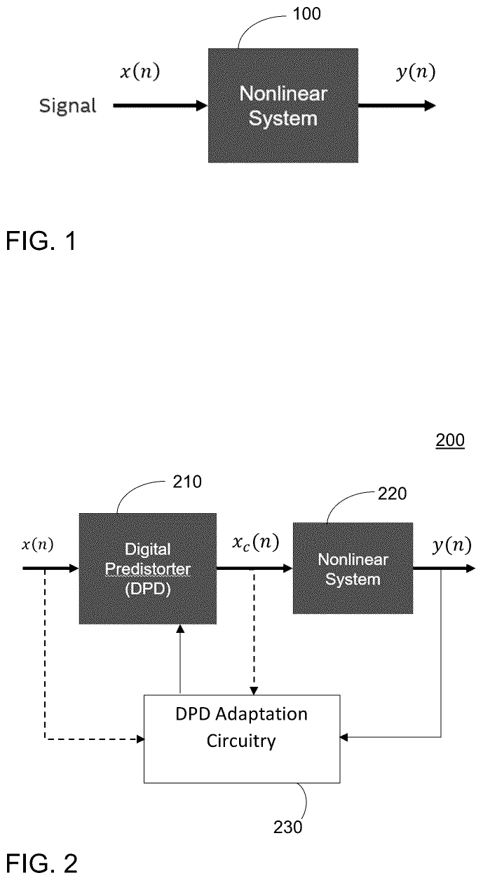

FIG. 1 shows a non-linear system 100. The non-linear system 100 (e.g., a digital-to-analog converter (DAC), a power amplifier (PA), etc.) receives an input signal x(n) and generate an output signal y(n). Due to the non-linear effects of the non-linear system 100, non-linear distortions such as harmonics and intermodulation may be present at the output signal y(n) of the non-linear system 100.

FIG. 2 shows an example system 200 including DPD circuitry 210 in front of a non-linear system 220 for linearizing the non-linear system 220, in which aspects of the present application may be implemented. The non-linear system 220 may include a DAC, a PA, or any other device having non-linear characteristics. In order to eliminate the unwanted distortion (such as harmonics and intermodulation) at the output of the non-linear system 220, DPD circuitry 210 is provided in front of the non-linear system 220. The DPD circuitry 210 receives an input signal x(n) and modifies/pre-distorts the input signal x(n) to generate a pre-distorted signal x_{c}(n). The DPD circuitry 210 may implement a mathematical model that produces an approximation of the inverse function of the non-linear system 220. By pre-distorting the input signal x(n), the non-linear effects of the non-linear system 220 can be compensated and the output of the non-linear system 220 may be linearized.

The non-linear system 220 may be modeled using any conventional models. For example, the non-linear system 220 may be modeled using polynomial functions to characterize the non-linear response of the system. The terms (e.g., polynomial terms) of the mathematical model for the DPD typically resemble that of the non-linearity with different parameters. Polynomial-based DPD systems receive input samples and applies the polynomial functions of the model to the input samples to generate pre-distorted DPD outputs. More specifically, the polynomial DPD systems may evaluate each of a set of polynomials given one or more input samples, apply the polynomial outputs as a non-linear gain factor to a function of the input samples, and sum the resulting samples to generate the DPD output. Assuming a suitable selection of modeling polynomials, the pre-distorted outputs may represent the inverse of the actual non-linearities of the non-linear system, which may be substantially canceled when the DPD outputs are applied as input to the non-linear system. The non-linear polynomial may be a linear combination of basis functions.

Polynomial-based DPD systems may either depend only on the current input sample (i.e., a memoryless polynomial model) or may depend on the current input sample in addition to one or more past input samples (i.e., a polynomial model with memory). The polynomial models with memory may present the DPD model as the sum of a plurality of terms, where each term is the product of a function of the current and/or previous input samples and a polynomial that is a function of the magnitude or power of the current or previous input samples. Accordingly, a DPD polynomial model with memory may evaluate each of a set of polynomials at one or more input samples, apply each polynomial output as a gain factor to a function of one or more input samples, and sum the resulting products to produce the overall DPD output.

A DPD polynomial model may need to evaluate each of the set of polynomials in order to produce each DPD output sample. In order to reduce computational burden, polynomial DPD systems may utilize one or more look-up tables (LUTs) to generate the DPD outputs. As opposed to directly evaluating each polynomial, DPD LUT systems may evaluate each of the polynomials over a wide range of input samples and may store the resulting outputs in a separate LUT. The LUT-based DPD systems may evaluate each LUT according to the received input samples and produce an LUT output value for each LUT. The LUT-based DPD systems may then produce the DPD output by applying the LUT output values as a set of gains to the corresponding function of input samples, thus avoiding direct evaluation of each polynomial. Besides polynomials, any non-linear functions may be approximated by the LUTs.

The DPD system 210 may utilize adaptable LUTs that dynamically adjust the LUT coefficients for each LUT based on feedback from the output of the non-linear system 220. A DPD adaptation circuitry 230 may perform adaptation of the LUT coefficients utilizing the feedback information derived from the output of the non-linear system 220. The DPD adaptation circuitry 230 may be a part of the DPD system 210. The DPD adaptation circuitry 230 may attempt to correct for any inaccuracies in the LUT coefficients that are observable through non-linearities detected in the output of the non-linear system 220. The DPD adaptation circuitry 230 may employ an adaptation scheme such as least square (LS), least mean square (LMS), or the like based on either indirect or direct learning to adapt the LUT coefficients of the DPD system 210. The DPD adaptation circuitry 230 may dynamically adapt the LUT coefficients over time based on observations of the outputs of the non-linear system 220.

Example schemes for reducing the complexity of DPD models are disclosed hereafter. The complexity of the DPD models can be reduced by considering only a discrete subset of delayed versions of the input signal (input samples). For example, for a particular power amplifier with certain memory characteristics, a subset of input signal delays (a subset of input samples) is enough to capture and compensate the characteristics of the power amplifier. Some example heuristic search procedures are disclosed herein for finding the right subset from a large set of options.

In examples, a digital pre-distortion model is written in the form of a sum of functions (terms) of sets of delayed input signals (delayed input samples), and a search for a subset of the functions (terms) and an effective small subset of delayed input samples for each function (term) is performed in an iterative fashion for a particular non-linear system (e.g., a PA). In examples, the search is performed iteratively and can be much more computationally efficient. It can also be done on-the fly by continuously updating the current selection.

In example, the apparatus 200 for reducing complexity of a DPD model for a non-linear system includes DPD circuitry 210, a non-linear system 220, and DPD adaptation circuitry 230. The DPD circuitry is configured to receive a block of input samples and process the block of input samples to generate a block of pre-distorted samples. The DPD circuitry 210 is configured to apply a pre-distortion function to the block of input samples to generate the block of pre-distorted samples. The pre-distortion function is represented by a sum of a plurality of terms, and each term is a function of one or more input samples.

The non-linear system 220 is configured to process the block of pre-distorted samples to generate a block of output samples. The DPD adaptation circuitry 230 is configured to perform an optimization process to determine a subset of the terms of the pre-distortion function and a subset of the input samples for each term of the pre-distortion function and configure the DPD circuitry 210 based on the determined subset of terms and the determined subset of input samples for each term. The DPD adaptation circuitry 230 is configured to perform an optimization process by solving an optimization function iteratively based on the block of input samples and the block of output samples to find parameters of the pre-distortion function that minimize the optimization function.

In one example, each term of the pre-distortion function may be multiplied with a corresponding multiplier factor with a constraint that the terms have a unit norm. For example, at a beginning of the optimization process, the pre-distortion function may be configured with an initial number of terms, and each term may be configured with an initial set of input samples, and the multiplier factors may be set to initial values, and the optimization process is performed iteratively. In one example, the DPD adaptation circuitry 230 may be configured to solve the optimization function iteratively using a gradient descent algorithm. Gradient descent is an iterative optimization algorithm for finding a local minimum of a function. To find the local minimum of a function using gradient descent, steps proportional to the negative of the gradient of the function is taken at the current point. The DPD adaptation circuitry 230 may be configured to compute a gradient of the optimization function with respect to parameters of the pre-distortion function and the multiplier factors and then update the parameters and the multiplier factors in a direction that reduces the optimization function and determine the subset of terms and the subset of input samples for each term based on the parameters and the multiplier factors that minimize the optimization function. In examples, any optimization method may be used to solve the optimization function. For example, the first order gradient-based methods, that are normally used in machine learning, such as stochastic gradient descent (SGD), adaptive moment estimation (ADAM), root mean square propagation (RMSPROP), or second order methods, e.g., conjugate gradient, limited memory Broyden-Fletcher-Goldfarb-Shanno (L-BFGS) method, Newton method, etc. may be used.

In examples, the DPD adaptation circuitry 230 may be configured to perform regularization (e.g., L1 regularization) on the multiplier factors and remove one or more terms associated with a multiplier factor that becomes zero after regularization. Alternatively, the DPD adaptation circuitry 230 may be configured to remove one or more terms associated with a multiplier factor that is lower than a predetermined threshold.

In another example, the DPD circuitry 210 may include a filter for selecting the subset of input samples for each term with a constraint of coefficients of the filter having a unit norm. For example, at a beginning of the optimization process, the pre-distortion function is configured with an initial number of terms, and each term is configured with an initial set of input samples, and coefficients of the filter are set to initial values, and the optimization process is performed iteratively. In one example, the DPD adaptation circuitry 230 may be configured to solve the optimization function iteratively using a gradient descent algorithm. For example, the DPD adaptation circuitry 230 may be configured to compute a gradient of the optimization function with respect to parameters of the pre-distortion function and the coefficients of the filter and then update the parameters and the coefficients of the filter in a direction that reduces the optimization function, and determine the subset of terms and the subset of input samples for each term based on the parameters and the coefficients that minimize the optimization function.

In examples, the DPD adaptation circuitry 230 may be configured to perform regularization (e.g., L1 regularization) on the coefficients of the filter and remove one or more terms associated with a coefficient that becomes zero after regularization.

In some examples, the subset of input samples assigned to each term may be two samples.

In some examples, each term of the pre-distortion function is multiplied with a corresponding multiplier factor with a constraint of the terms having a unit norm, and the subset of input samples are selected for each term by filtering the input samples with a filter with a constraint of coefficients of the filer having a unit norm. The DPD adaptation circuitry 230 may be configured to solve the optimization function iteratively using a gradient descent algorithm. The DPD adaptation circuitry 230 may be configured to compute a gradient of the optimization function with respect to parameters of the pre-distortion function, the multiplier factors, and the coefficients of the filter and then update the parameters, the multiplier factors, and the coefficients in a direction that reduces the optimization function, and determine the subset of terms and the subset of input samples for each term based on the parameters, the multiplier factors, and the coefficients that minimize the optimization function.

Hereafter, examples will be explained in detail with reference to a power amplifier as an example of the non-linear system. However, the examples can be applied to any non-linear system other than a power amplifier.

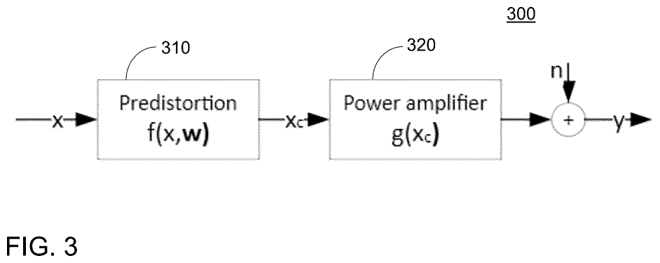

FIG. 3 shows an example DPD system for a power amplifier. The system 300 includes a DPD circuitry 310 placed in front of a PA 320. The DPD circuitry 310 applies a pre-distortion function to the input signal x before the PA 320 with the goal to reverse the unwanted artifacts (non-linear characteristics) of the power amplifier 320. The output of the DPD circuitry 310 and the output of the PA 320 may be written as:

$${x}_{c} = f ( x ; w ) ; and \qquad Equation ( 1 )$$

$$y = g ( {x}_{c} ) + n ; \qquad Equation ( 2 )$$

where x is a complex-valued input signal, ƒ is the pre-distortion function with M parameter sets, w=[w₁, w₂, . . . , w_{M}]^{T}, g is the non-linear function of the power amplifier 320, y is the measured complex-valued output signal from the power amplifier 320, and n is a noise added to the output of the power amplifier 320, which may be modeled as a Gaussian noise.

A general pre-distortion function is very complex as it depends on many input samples from the past. In examples, the pre-distortion function is approximated by a sum of a set of sub-functions where each sub-function depends on a small subset of input samples from the past. An example of the digital pre-distortion model is a generalized memory polynomial model. Alternatively, a different model may be used. The pre-distortion function based on the generalized memory polynomial model may be written as follows:

$${x}_{c} [ t ] = f ( x ; w , T ) = {\sum }_{i = 0}^{{N}_{terms} - 1} {f}_{i} ( x [ t - {T}_{i , 0} ] , … , x [ t - {T}_{i , {S}_{i} - 1} ] ; {w}_{i} ) , \qquad Equation ( 3 )$$

where x[t−T_{i,S}] is the value of the complex input signal (input sample) from the past at time t−T_{i,S}, Nₜₑᵣₘₛ is the number of functions (terms) in the summation in Equation (3), ƒᵢ is a function of a set of Sᵢ delayed input signal values (input samples), wᵢ is the parameters of function ƒᵢ, w is the concatenation of all the function parameters wᵢ, and Tis a delay of the input samples (e.g., from 0 to the maximum D)

The functions ƒᵢ in Equation (3) may also be referred to as “terms.” The pre-distortion function is approximated by a sum of a set of functions ƒᵢ that are summed over multiple (Nₜₑᵣₘₛ) terms. Each function ƒᵢ depends on a small set of input samples (Sᵢ input samples) from the past. Examples disclosed herein provide methods to select a set of functions (terms) and a (small) set of input samples for each function (term) to reduce the complexity of the DPD model.

In examples, the functions ƒᵢ in Equation (3) may be computed/approximated using look-up tables (LUTs). An example DPD model using a generalized memory polynomial formula with LUTs may be written as follows:

$${x}_{c} [ t ] = f ( x ; w , T ) = {\sum }_{i = 0}^{{N}_{terms} - 1} {l}_{i} ( \vert x [ t - {T}_{i , 0} ] \vert ; {w}_{i} ) x [ t - {T}_{i , 1} ] , \qquad Equation ( 4 )$$

where lᵢ is complex valued non-linear functions approximated using LUTs with linear interpolation, wᵢ is the LUT values of the i-th function (term) that are concatenated together from the parameter vector w, and T is a set of Nₜₑᵣₘₛ pairs of time delays used in the example model.

In the example model using a generalized memory polynomial with LUTs in Equation (4), each term i of this model may be defined by two delays T_{i,0} and T_{i,1}. Each term i (function) depends only on two samples from the past at times T_{i,0} and T_{i,1}. However, it should be noted that this model is merely one example, and the model may be chosen that each function may depend on any number of past input samples (e.g., 3, 4, 5, or any number). For a given power amplifier, the DPD model may selected/determined by finding the number of terms (Nₜₑᵣₘₛ) and a corresponding set of delay pairs T_{i,0} and T_{i,1} for each term.

For a given power amplifier a proper DPD model needs to be selected to achieve the right suppression of the power amplifier artifact at limited compute costs. Many DPD models have been proposed in the literature and most can be described as above in general form. Let D be the maximum delay of the input signal. For a fixed number of terms (Nₜₑᵣₘₛ), it can be shown that the number of combinations of the delays is as follows:

$$\frac{{D}^{2} !}{{N}_{terms} ! ( {D}^{2} - {N}_{terms} ) !} .$$

For example, for D=64 and Nₜₑᵣₘₛ=32, the number of combinations will be greater than 10⁸⁰. For a general form with S delays per term this would be even greater. This is typically too large set to evaluate, and some heuristics are usually used to reduce the search space.

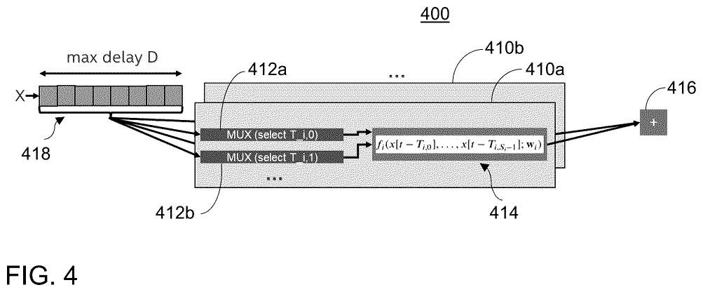

FIG. 4 is a schematic diagram of an example DPD circuitry. The DPD circuitry 400 may include a plurality of circuit blocks 410a, 410b, . . . for evaluating the terms of the pre-distortion function. As shown in Equation (3), the pre-distortion function may be written as a sum of a plurality of terms (functions ƒᵢ). Each circuit block 410a, 410b, . . . is for evaluating a corresponding term ƒᵢ of the pre-distortion function. Each circuit block 410a, 410b, . . . includes a plurality of multiplexers 412a, 412b, . . . for selecting the input sample(s) for the corresponding term ƒᵢ among the input samples of a size of maximum delay D. A set of D samples of the input signal x may be kept in a first-in first-out (FIFO) buffer 418 and then forwarded to each of the circuit blocks 410a, 410b, . . . . The input samples enter each of the circuit blocks 410a, 410b, . . . and one or more of the input samples are selected by the multiplexers 412a, 412b, . . . for evaluating the corresponding term ƒᵢ by circuitry 414. The first multiplexer 412a selects the first input sample for the term, the second multiplexer 412b selects the second input sample for the term, and so on. Each term ƒᵢ is evaluated with the selected input samples and all terms are then summed over by the combiner 416.

A model selection may be done based on a block of N input and output samples trying to predict the input of the power amplifier from the observed output of the power amplifier. The goal is to find the minimum of the optimization function L (cost function) as follows:

$$L ( w , T ) = {\sum }_{N} {‖ f ( y [ i ] ; w , T ) - x [ i ] ‖}^{2} . \qquad Equation ( 5 a )$$

For a given set of Nₜₑᵣₘₛ and delays T (input samples for each of the terms), there is usually an efficient procedure to find the optimal parameters w of the pre-distortion function. However, finding the optimal set of delays is difficult. Equation (5a) is an example indirect parameter estimation optimization function. The optimization procedure may be applied to the direct parameter estimation as well, for example as in Equation (5b). The gradient descent on the direct optimization requires approximation of the derivative of the system non-linear characteristic g.

$$L ( w , T ) = {\sum }_{N} {‖ y [ i ] - x [ i ] ‖}^{2} = {\sum }_{N} {‖ g ( f ( x [ i ] ; w , T ) ) - x [ i ] ‖}^{2} . \qquad Equation ( 5 b )$$

The delays T of input samples have discrete values and typically there are many choices as described above. For a given set of delays T, the optimal set of parameters w (e.g., LUT values) can be estimated, for example, by a gradient descent optimization procedure or, in case where the model is linear with respect to the parameters w, by a closed form least square solution. The procedure usually goes over all different combinations for the delays T, and the best parameters w of the pre-distortion function are found to minimize the optimization function L. The best set of delays T and the number of terms (Nₜₑᵣₘₛ) are the one that minimizes the optimization function L. In common practice the optimization function can be evaluated on a separate validation set of data to determine the final value for selection.

In examples, a weighted terms extension is used to determine the number of terms (Nₜₑᵣₘₛ) of the pre-distortion function and a set of delays (input samples) for each term of the pre-distortion function. The example schemes disclosed herein aim to estimate the added value of each term. In that way it would be possible to select the important terms with important delay combinations.

In examples, multiplier factors m=[m₀, m₁, . . . , m_{N}_{_{terms−1}}] are introduced to estimate the impact of each term, with a constraint that the term functions have a unit norm. The pre-distortion function with the multiplier factors may be written as:

$$f ( x ; w , T , m ) = {\sum }_{i = 0}^{{N}_{terms} - 1} {m}_{i} {f}_{i}^{n} ( x [ t - {T}_{i , 0} ] , … , x [ t - {T}_{i , {S}_{i} - 1} ] ; {w}_{i} ) , \qquad Equation ( 6 )$$

where ƒᵢⁿ is a normalized function of the original function ƒᵢ, which may be written as:

$${f}_{i}^{n} = \frac{{f}_{i}}{\sqrt{\int {\vert {f}_{i} \vert}^{2}}} . \qquad Equation ( 7 )$$

In case where the function (term) is represented as an LUT with N_{seg} segments, this may be achieved by dividing the LUT values by the sum of absolute values of the LUT. This is equivalent to the optimization with the constraint:

$$\sqrt{\int {\vert {f}_{i} \vert}^{2}} = 1. \qquad Equation ( 8 )$$

In case of LUT, the values should sum to 1:

$$\sqrt{{\sum }_{{N}_{seg}} {w}_{i} [ j ] {{w}_{i} [ j ]}^{*}} = 1. \qquad Equation ( 9 )$$

where wᵢ[j] is an LUT entry, and wᵢ[j]* is a complex conjugate of wᵢ[j].

In addition, it is beneficial to remove some unnecessary/less relevant terms in the pre-distortion function in Equation (6). For example, a regularization (e.g., L1 regularization) may be performed on the multiplier factors mᵢ.

L1 regularization is a technique commonly used in machine learning and statistics to prevent overfitting and improve the interpretability of models. L1 regularization achieves this by adding a penalty term to the loss function based on the L1 norm of the coefficient vector. By incorporating the sum of absolute values of the coefficients as the penalty term, L1 regularization encourages sparsity in the model. Sparsity refers to the phenomenon that some coefficients are driven to zero, effectively performing feature selection. L1 regularization not only helps in controlling the complexity of the model but also allows to identify and prioritize the most important features. By shrinking some coefficients to zero, L1 regularization effectively eliminates the less important features, leaving only the most relevant ones. The cost function in L1 regularization is modified by adding the L1 norm of the coefficient vector multiplied by a regularization parameter (λ). The regularization parameter controls the strength of the penalty applied to the coefficients. The modified cost function can be expressed as: Cost=Loss+λ×L1_norm (coefficients). By increasing the value of λ, the penalty on large coefficients becomes stronger. This encourages the model to shrink the coefficients towards zero, effectively reducing the impact of less important features and promoting sparsity in the coefficient vector. By driving some coefficients to zero, L1 regularization helps identify the most important features.

In examples, the optimization procedure is performed for determining the number of terms (Nₜₑᵣₘₛ) of the pre-distortion function and a set of delays (input samples) for each term of the pre-distortion function using a weighted terms extension. The procedure starts with configuring the pre-distortion function with a large (arbitrary) number of terms (N_{terms_0}) and large (arbitrary) possible delay combinations (T_0) for each term, where both may be initially set larger than necessary. For example, the delay combinations for each term may be set to the combinations D² for the generalized memory polynomial model, where D is the maximum delay of the input signal. Initially, the multiplier factors mᵢ may be set to a small value, e.g., 1/N_{terms_0}.

The optimization function L with regularization (e.g., L1 regularization) with weight β may be written as follows:

$$L ( w , T , m ) = {\sum }_{N} {‖ f ( y [ i ] ; w , T , m ) - x [ i ] ‖}^{2} + β {\sum }_{{N}_{terms}} \vert {m}_{i} \vert . \qquad Equation ( 10 )$$

with a constraint \sqrt{∫|ƒᵢ|³}=1.

Optimization is then performed iteratively to solve the optimization function L(w,T,m) based on a block of input samples x(n) and a corresponding block of output samples y(n) from the non-linear system 220. By solving the optimization function L, the number (Nₜₑᵣₘₛ) of terms for the pre-distortion function, the sample delays (Tᵢ) for each term of the pre-distortion function, the parameters w for the pre-distortion function, and the multiplier factor mᵢ can be determined.

The optimization may be performed using any optimization techniques. For example, a standard gradient descent procedure may be performed where the gradient of L with respect to the parameters w and mᵢ is calculated and then the parameters w and mᵢ are updated in a direction which reduces the optimization function L. For example, the optimization function may be solved for each Tᵢ for the best w iteratively while sweeping all Tᵢ values. Alternatively, the optimization function may be solved for some preselected set of Tᵢ based on some prior knowledge about the PAs. After a number of iterations, the optimization procedure will converge to w and mᵢ that minimize the optimization function L. The number of terms (Nₜₑᵣₘₛ) of the pre-distortion function and the input sample delays (Tᵢ) for each term of the pre-distortion function may be selected as the ones with the highest weights of mᵢ as the final set of terms of the pre-distortion function.

With sparsity regularization beta, some of the weights mᵢ may become zero or very small and they can be removed. In some examples, either with or without regularization, the terms that do not contribute much will have a very low weight value of mᵢ and those terms may be removed. For example, a small real valued threshold may be used to remove the terms with mᵢ that is less than the threshold. The removal of the less important terms may be done during the optimization steps as soon as they become zero or very small below the threshold.

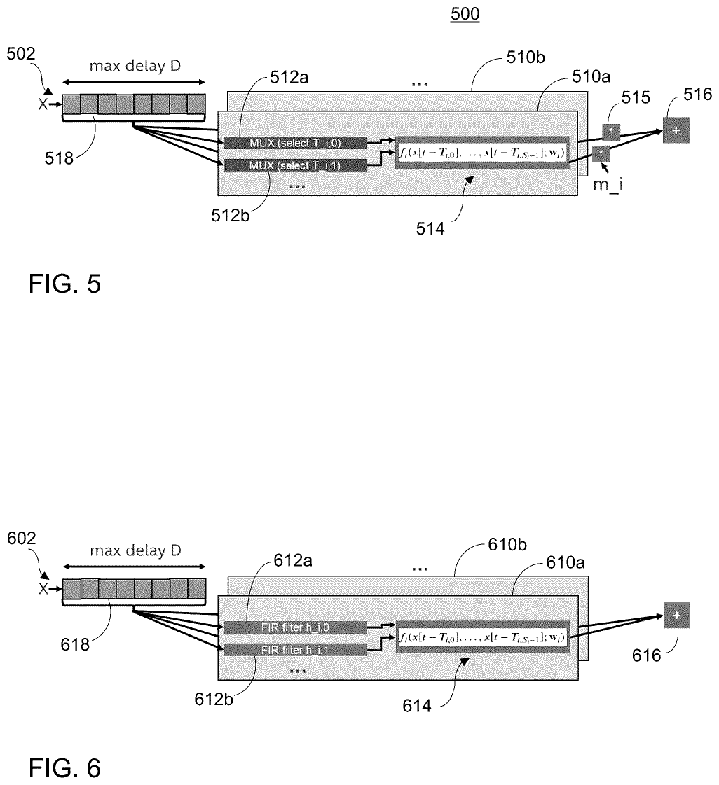

FIG. 5 is a schematic diagram of an example DPD circuitry using the weighted terms extension. The DPD circuitry 500 may include a plurality of circuit blocks 510a, 510b for evaluating the terms of the pre-distortion function. As shown in Equation (3), the pre-distortion function may be written as a sum of a plurality of terms (functions ƒᵢ). Each circuit block 510a, 510b is for evaluating a corresponding term of the pre-distortion function. Each circuit block 510a, 510b includes a plurality of multiplexers 512a, 512b for selecting certain input sample(s) for the corresponding term among the input samples 502 of a size of maximum delay D. The number of terms and a set of input samples for each term are determined as disclosed above, and the DPD circuitry 210 is adapted by the DPD adaptation circuitry 230 accordingly. A set of D samples 502 of the input signal x may be kept in a FIFO buffer 518 and then forwarded to each of the circuit blocks 510a, 510b. The input samples 502 enter each of the circuit blocks 510a, 510b and one or more of the input samples 502 are selected by the multiplexers 512a, 512b as configured by the DPD adaptation circuitry 230 for evaluating the corresponding term ƒᵢ by circuitry 514. The first multiplexer 512a selects the first input sample for the term, the second multiplexer 512b selects the second input sample for the term, and so on. Each term is evaluated with the selected input samples and each term output is multiplied by a multiplier 515 with the corresponding multiplier factor mᵢ. All terms are then summed over by the combiner 516. The multiplication by mᵢ is needed during the search for the right set of normalized terms. Once the term selection is done it is possible to allow the terms to be un-normalized and absorb the multiplication by mᵢ inside the function ƒᵢ computation.

In another example, the discrete signal delays for each term may be represented as “soft-delays” that can be optimized directly. This is based on the fact that a finite impulse response (FIR) filter of D-taps is a more generic representation of a fixed delay selection Tᵢ. A filter with all the weights/coefficients equal to 0 and only the tap at Tᵢ equal to 1 is equivalent to the hard detection. In this example, filter coefficients now replace the delays Tᵢ. It is a more general representation of the delays. For example, a filter with all zeros and only 1 at the delay Tᵢ is equivalent to selecting the sample at Tᵢ.

The pre-distortion model with an FIR filter may be written as:

$$f ( x ; w , h ) = {\sum }_{i = 0}^{{N}_{terms} - 1} {f}_{i} ( {\sum }_{D} x [ t - k ] {h}_{i , 0} [ k ] , … , {\sum }_{D} x [ t - k ] {h}_{i , {S}_{i} - 1} [ k ] ; {w}_{i} ) , \qquad Equation ( 11 )$$

where h_{i,0}, . . . , h_{i,S}_{ᵢ}₋₁ are FIR filter coefficients, and the filter coefficients for all terms are represented as h.

This is a differential form that can be optimized as a non-linear optimization problem. For a given number of terms Nₜₑᵣₘₛ and maximum delay D, the optimization problem can be formulated as follows:

$$L ( w , h ) = {\sum }_{N} {‖ f ( y [ i ] ; w , h ) - x [ i ] ‖}^{2} . \qquad Equation ( 12 )$$

As the filters have more degrees of freedom and can in general change the signal power, the filter coefficients may be constrained, for example to have a unit norm.

\sqrt{Σ_{D}h_{i,s}[k]²}=1.

Optimization is performed iteratively to solve the optimization function L(w,h) based on a block of input samples x(n) and a corresponding block of output samples y(n) from the non-linear system 220. By solving the optimization function L, the number (Nₜₑᵣₘₛ) of terms for the pre-distortion function, the parameters w, and filter coefficients h for the pre-distortion function can be determined. The optimization becomes a non-linear optimization problem with the constraints.

The optimization procedure for determining the number of terms (Nₜₑᵣₘₛ) of the pre-distortion function and a set of delays (input samples) for each term of the pre-distortion function may start with configuring the pre-distortion function with a large (arbitrary) number of terms (N_{terms_0}). The filter coefficients h may be initially set randomly.

For a fixed Nₜₑᵣₘₛ, the filter coefficients as a more general representation of the delays for each term may be determined using some optimization procedure, e.g., gradient descent. The gradient descent algorithm may be used to compute the derivative of L with the respect to the parameters w and the filter coefficients h and update the parameter w and the filter coefficients h to reduce L. The parameters w and the filter coefficients h are updated in a direction which reduces the optimization function L. After a number of iterations, the minimum of L can be achieved. The number (Nₜₑᵣₘₛ) of terms for the pre-distortion function and the sample delays (Tᵢ) for each term of the pre-distortion function are then selected based on the parameters w and the filter coefficients h that provide the minimum L. Due to the regularization of the filter coefficients, the filters may correspond to just a delay. They may also represent a linear combination of a number of delayed samples. Due to the regularization the linear combination should be not complex to compute.

The filters instead of a simple selection by a multiplexer can be much more costly in terms of compute and potential hardware implementation. Therefore, it would be useful to reduce the number of filter taps. One way of doing so is by introducing a complexity reduction prior on the filter taps, for example L1 regularization. Besides the regularization there are other ways to constrain the filter complexity cost. For example, small filters with a larger discrete delay may be introduced as a constraint. Alternatively, multiple levels of filtering with smaller filters may be used.

In this example, the constrained optimization problem may become as follows:

$$L ( w , h ) = {\sum }_{N} {‖ f ( y [ i ] ; w , h ) - x [ i ] ‖}^{2} + {\sum }_{i = 0}^{{N}_{terms}} {α}_{i} {\sum }_{D} \vert {h}_{i , {S}_{i}} [ k ] \vert . \qquad Equation ( 13 )$$

with \sqrt{Σ_{D}h_{i,s}[k]²}=1. αᵢ are empirically selected constants that control the level of sparsity to be enforced on the filter coefficients during the training. It may be a small value between 0 and 1.

FIG. 6 is a schematic diagram of an example DPD circuitry using the FIR filters for selecting the input samples for the terms. The DPD circuitry 600 may include a plurality of circuit blocks 610a, 610b for evaluating the terms of the pre-distortion function. As shown in Equation (3), the pre-distortion function may be written as a sum of a plurality of terms (functions ƒᵢ). Each circuit block 610a, 610b is for evaluating a corresponding term of the pre-distortion function. Each circuit block 610a, 610b includes a plurality of filters 612a, 612b (e.g., FIR filters) for selecting the input sample(s) for the corresponding term among the input samples of a size of maximum delay D. The number of terms of the pre-distortion function and a set of input samples for each term of the pre-distortion function are determined as disclosed above, and the DPD circuitry 210 is adapted by the DPD adaptation circuitry 230 accordingly. A set of D samples 602 of the input signal x may be kept in a FIFO buffer 618 and then forwarded to each of the circuit blocks 610a, 610b. The input samples 602 enter each of the circuit blocks 610a, 610b and one or more of the input samples 602 are selected by the filters 612a, 612b as configured by the DPD adaptation circuitry 230, for evaluating the corresponding term ƒᵢ by circuitry 614. The first filter 612a selects the first input sample for the term, the second filter 612b selects the second input sample for the term, and so on. Each term is evaluated with the selected input samples and all terms are then summed over by the combiner 616.

In another example, the above-described two examples can be combined. The combined optimization problem becomes as follows:

$$L ( w , h , m ) = {\sum }_{N} {‖ f ( y [ i ] ; w , h , m ) - x [ i ] ‖}^{2} + {\sum }_{i = 0}^{{N}_{terms}} {α}_{i} {\sum }_{D} \vert {h}_{i , {S}_{i}} [ k ] \vert + β {\sum }_{{N}_{terms}} \vert {m}_{i} \vert . \qquad Equation ( 13 )$$

with constraints \sqrt{Σ_{D}h_{i,s}[k]²}=1, and \sqrt{∫|ƒᵢ|²}=1.

Optimization may then be performed iteratively to solve the optimization function L(w,h,m) based on a block of input samples x(n) and a block of output samples y(n) from the non-linear system 220 as disclosed above. By solving the optimization function L, the number (Nₜₑᵣₘₛ) of terms for the pre-distortion function, and the parameters w, mᵢ, and h for the pre-distortion function can be determined. For example, the gradient descent algorithm may be used to compute the derivative of L with the respect to the parameters w, mᵢ, and h and updates the parameters w, mᵢ, and h to reduce L. After a number of iterations, the minimum of L can be achieved. The number of terms (Nₜₑᵣₘₛ) of the pre-distortion function may be selected as the ones with the highest weights of mᵢ as the final set of terms of the pre-distortion function.

Various initialization and combination strategies can be constructed. For example, in an on-line application, some random terms or some selection of terms made in some other way may be added and the terms that do not contribute with a small mᵢ can be removed. In this way the model can keep updating the form and adapting to the changes.

The example schemes disclosed may be implemented either off-line or on-line. The system (e.g., the DPD adaptation circuitry 230) may be configured to implement the schemes disclosed above and perform the optimization to select the number of terms and the delay samples for each term in accordance with the examples disclosed.

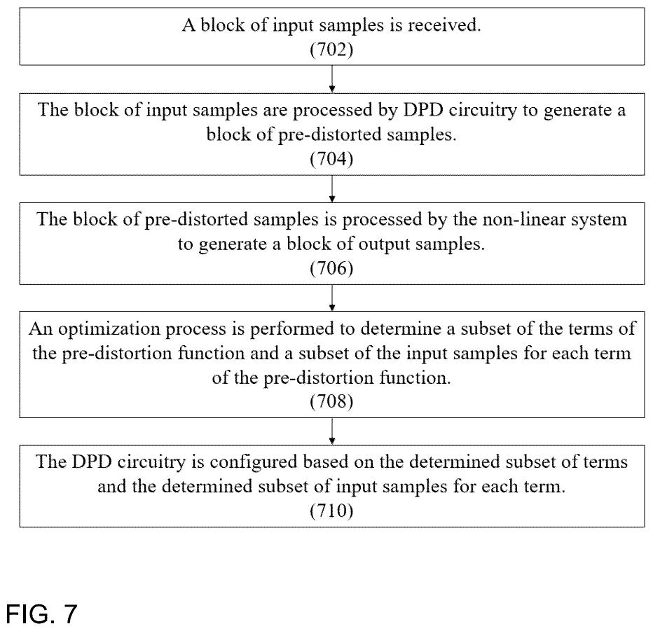

FIG. 7 is a flow diagram of an example process for reducing complexity of DPD model for a non-linear system. A block of input samples is received (702). The block of input samples are processed by DPD circuitry to generate a block of pre-distorted samples (704). The DPD circuitry is configured to apply a pre-distortion function to the block of input samples to generate the block of pre-distorted samples. The pre-distortion function is represented by a sum of a plurality of terms, and each term is a function of one or more input samples.

The block of pre-distorted samples is processed by the non-linear system to generate a block of output samples (706). An optimization process is then performed to determine a subset of the terms of the pre-distortion function and a subset of the input samples for each term of the pre-distortion function (708). The optimization process is performed by solving an optimization function iteratively based on the block of input samples and the block of output samples to find parameters of the pre-distortion function that minimize the optimization function. The DPD circuitry is configured based on the determined subset of terms and the determined subset of input samples for each term (710).

In one example, each term of the pre-distortion function may be multiplied with a corresponding multiplier factor with a constraint that the terms have a unit norm. For example, at a beginning of the optimization process, the pre-distortion function may be configured with an initial number of terms, and each term may be configured with an initial set of input samples, and the multiplier factors may be set to initial values, and the optimization process is performed iteratively. In one example, the optimization function may be solved iteratively using a gradient descent algorithm. A gradient of the optimization function with respect to parameters of the pre-distortion function and the multiplier factors is calculated and then the parameters and the multiplier factors are updated in a direction that reduces the optimization function, and the subset of terms and the subset of input samples for each term are determined based on the parameters and the multiplier factors that minimize the optimization function.

In examples, regularization (e.g., L1 regularization) may be performed on the multiplier factors and one or more terms associated with a multiplier factor that becomes zero after regularization may be removed. Alternatively, one or more terms associated with a multiplier factor that is lower than a predetermined threshold may be removed.

In another example, the subset of input samples may be selected for each term by filtering the input samples with a filter with a constraint that coefficients of the filer have a unit norm. For example, at a beginning of the optimization process, the pre-distortion function is configured with an initial number of terms, and each term is configured with an initial set of input samples, and coefficients of the filter are set to initial values, and the optimization process is performed iteratively. In one example, the optimization function is solved iteratively using a gradient descent algorithm wherein a gradient of the optimization function with respect to parameters of the pre-distortion function and the coefficients of the filter is calculated and then the parameters and the coefficients of the filter are updated in a direction that reduces the optimization function, and the subset of terms and the subset of input samples for each term are determined based on the parameters and the coefficients that minimize the optimization function.

In examples, regularization (e.g., L1 regularization) may be performed on the coefficients of the filter and one or more terms associated with a coefficient that becomes zero after regularization may be removed.

In some examples, the subset of input samples assigned to each term may be two samples.

In some examples, each term of the pre-distortion function is multiplied with a corresponding multiplier factor and the terms have a unit norm, and the subset of input samples are selected for each term by filtering the input samples with a filter, and coefficients of the filer have a unit norm. The optimization function may be solved iteratively using a gradient descent algorithm. A gradient of the optimization function with respect to parameters of the pre-distortion function, the multiplier factors, and the coefficients of the filter is calculated and then the parameters, the multiplier factors, and the coefficients are updated in a direction that reduces the optimization function, and the subset of terms and the subset of input samples for each term are determined based on the parameters, the multiplier factors, and the coefficients that minimize the optimization function.

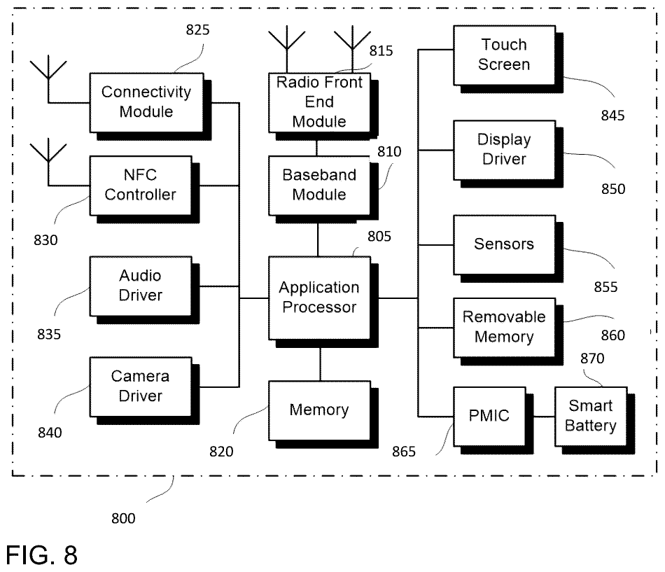

FIG. 8 illustrates a user device 800 in which the examples disclosed herein may be implemented. For example, the examples disclosed herein may be implemented in the radio front-end module 815, in the baseband module 810, etc. The user device 800 may be a mobile device in some aspects and includes an application processor 805, baseband processor 810 (also referred to as a baseband module), radio front end module (RFEM) 815, memory 820, connectivity module 825, near field communication (NFC) controller 830, audio driver 835, camera driver 840, touch screen 845, display driver 850, sensors 855, removable memory 860, power management integrated circuit (PMIC) 865 and smart battery 870.

In some aspects, application processor 805 may include, for example, one or more CPU cores and one or more of cache memory, low drop-out voltage regulators (LDOs), interrupt controllers, serial interfaces such as serial peripheral interface (SPI), inter-integrated circuit (I2C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband module 810 may be implemented, for example, as a solder-down substrate including one or more integrated circuits, a single packaged integrated circuit soldered to a main circuit board, and/or a multi-chip module containing two or more integrated circuits.

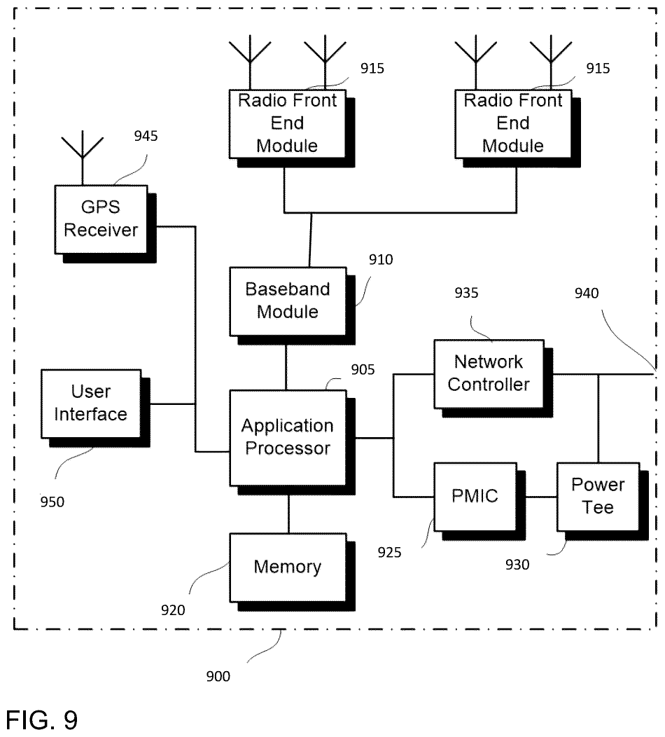

FIG. 9 illustrates a base station or infrastructure equipment radio head 900 in which the examples disclosed herein may be implemented. For example, the examples disclosed herein may be implemented in the radio front-end module 915, in the baseband module 910, etc. The base station radio head 900 may include one or more of application processor 905, baseband modules 910, one or more radio front end modules 915, memory 920, power management circuitry 925, power tee circuitry 930, network controller 935, network interface connector 940, satellite navigation receiver module 945, and user interface 950.

In some aspects, application processor 905 may include one or more CPU cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband processor 910 may be implemented, for example, as a solder-down substrate including one or more integrated circuits, a single packaged integrated circuit soldered to a main circuit board or a multi-chip module containing two or more integrated circuits.

In some aspects, memory 920 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto resistive random access memory (MRAM) and/or a three-dimensional crosspoint memory. Memory 920 may be implemented as one or more of solder down packaged integrated circuits, socketed memory modules and plug-in memory cards.

In some aspects, power management integrated circuitry 925 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 930 may provide for electrical power drawn from a network cable to provide both power supply and data connectivity to the base station radio head 900 using a single cable.

In some aspects, network controller 935 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 945 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 945 may provide data to application processor 905 which may include one or more of position data or time data. Application processor 905 may use time data to synchronize operations with other radio base stations.

In some aspects, user interface 950 may include one or more of physical or virtual buttons, such as a reset button, one or more indicators such as light emitting diodes (LEDs) and a display screen.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for reducing complexity of a DPD model for a non-linear system. The method includes receiving a block of input samples, processing the block of input samples by DPD circuitry to generate a block of pre-distorted samples, wherein the DPD circuitry is configured to apply a pre-distortion function to the block of input samples to generate the block of pre-distorted samples, wherein the pre-distortion function is represented by a sum of a plurality of terms, and each term is a function of one or more input samples, processing the block of pre-distorted samples by the non-linear system to generate a block of output samples, performing an optimization process to determine a subset of the terms of the pre-distortion function and a subset of the input samples for each term of the pre-distortion function, wherein the optimization process is performed by solving an optimization function iteratively based on the block of input samples and the block of output samples to find parameters of the pre-distortion function that minimize the optimization function, and configuring the DPD circuitry based on the determined subset of terms and the determined subset of input samples for each term.

Another example, (e.g., example 2) relates to a previously described example (e.g., example 1), wherein each term of the pre-distortion function is multiplied with a corresponding multiplier factor with a constraint that the terms have a unit norm.

Another example, (e.g., example 3) relates to a previously described example (e.g., example 2), wherein, at a beginning of the optimization process, the pre-distortion function is configured with an initial number of terms, and each term is configured with an initial set of input samples, and the multiplier factors are set to initial values, and the optimization process is performed iteratively.

Another example, (e.g., example 4) relates to a previously described example (e.g., example 3), wherein the optimization function is solved iteratively using a gradient descent algorithm wherein a gradient of the optimization function with respect to parameters of the pre-distortion function and the multiplier factors is calculated and then the parameters and the multiplier factors are updated in a direction that reduces the optimization function, and the subset of terms and the subset of input samples for each term are determined based on the parameters and the multiplier factors that minimize the optimization function.

Another example, (e.g., example 5) relates to a previously described example (e.g., example 4), wherein the method further includes performing regularization on the multiplier factors and removing one or more terms associated with a multiplier factor that becomes zero after regularization.

Another example, (e.g., example 6) relates to a previously described example (e.g., any one of examples 4-5), wherein the method further includes removing one or more terms associated with a multiplier factor that is lower than a predetermined threshold.

Another example, (e.g., example 7) relates to a previously described example (e.g., any one of examples 1-6), wherein the subset of input samples are selected for each term by filtering the input samples with a filter with a constraint that coefficients of the filter have a unit norm.

Another example, (e.g., example 8) relates to a previously described example (e.g., example 7), wherein, at a beginning of the optimization process, the pre-distortion function is configured with an initial number of terms, and each term is configured with an initial set of input samples, and coefficients of the filter are set to initial values, and the optimization process is performed iteratively.

Another example, (e.g., example 9) relates to a previously described example (e.g., example 8), wherein the optimization function is solved iteratively using a gradient descent algorithm wherein a gradient of the optimization function with respect to parameters of the pre-distortion function and the coefficients of the filter is calculated and then the parameters and the coefficients of the filter are updated in a direction that reduces the optimization function, and the subset of terms and the subset of input samples for each term are determined based on the parameters and the coefficients that minimize the optimization function.

Another example, (e.g., example 10) relates to a previously described example (e.g., any one of examples 8-9), wherein the method further includes performing regularization on the coefficients of the filter and removing one or more terms associated with a coefficient that becomes zero or below a predetermined threshold after regularization.

Another example, (e.g., example 11) relates to a previously described example (e.g., any one of examples 1-10), wherein the subset of input samples assigned to each term are two samples.

Another example, (e.g., example 12) relates to a previously described example (e.g., any one of examples 1-11), wherein each term of the pre-distortion function is multiplied with a corresponding multiplier factor with a constraint that the terms have a unit norm, and the subset of input samples are selected for each term by filtering the input samples with a filter with a constraint that coefficients of the filer have a unit norm. The optimization function is solved iteratively using a gradient descent algorithm wherein a gradient of the optimization function with respect to parameters of the pre-distortion function, the multiplier factors, and the coefficients of the filter is calculated and then the parameters, the multiplier factors, and the coefficients are updated in a direction that reduces the optimization function, and the subset of terms and the subset of input samples for each term are determined based on the parameters, the multiplier factors, and the coefficients that minimize the optimization function.

Another example, (e.g., example 13) relates to an apparatus for reducing complexity of a DPD model for a non-linear system. The apparatus includes DPD circuitry, a non-linear system, and DPD adaptation circuitry. The DPD circuitry is configured to receive input samples, and process the input samples to generate pre-distorted samples, wherein the DPD circuitry is configured to apply a pre-distortion function to the input samples to generate the pre-distorted samples, wherein the pre-distortion function is represented by a sum of a plurality of terms, and each term is a function of one or more input samples. The non-linear system is configured to process the pre-distorted samples to generate output samples. The DPD adaptation circuitry is configured to determine a subset of the terms of the pre-distortion function and a subset of the input samples for each term of the pre-distortion function and configure the DPD circuitry based on the determined subset of terms and the determined subset of input samples for each term, wherein the DPD adaptation circuitry is configured to solve an optimization function iteratively based on the input samples and the output samples to find parameters of the pre-distortion function that minimize the optimization function.

Another example, (e.g., example 14) relates to a previously described example (e.g., example 13), wherein each term of the pre-distortion function is multiplied with a corresponding multiplier factor with a constraint that the terms have a unit norm, wherein, at a beginning of optimization process, the pre-distortion function is based on an initial number of terms, and each term is based on an initial set of input samples, and the multiplier factors are set to initial values. The optimization process may be performed iteratively.

Another example, (e.g., example 15) relates to a previously described example (e.g., example 14), wherein the DPD adaptation circuitry is configured to solve the optimization function iteratively using a gradient descent algorithm wherein a gradient of the optimization function with respect to parameters of the pre-distortion function and the multiplier factors is calculated and then the parameters and the multiplier factors are updated in a direction that reduces the optimization function, and the subset of terms and the subset of input samples for each term are determined based on the parameters and the multiplier factors that minimize the optimization function.

Another example, (e.g., example 16) relates to a previously described example (e.g., example 15), wherein the DPD adaptation circuitry is configured to perform regularization on the multiplier factors and remove one or more terms associated with a multiplier factor that becomes zero or below a predetermined threshold after regularization.

Another example, (e.g., example 17) relates to a previously described example (e.g., any one of examples 13-16), wherein the DPD circuitry include a filter for selecting the subset of input samples for each term with a constraint that coefficients of the filter have a unit norm, wherein, at a beginning of the optimization process, the pre-distortion function is based on an initial number of terms, and each term is based on an initial set of input samples, and coefficients of the filter are set to initial values. The optimization process may be performed iteratively.

Another example, (e.g., example 18) relates to a previously described example (e.g., example 17), wherein the DPD adaptation circuitry is configured to solve the optimization function iteratively using a gradient descent algorithm wherein a gradient of the optimization function with respect to parameters of the pre-distortion function and the coefficients of the filter is calculated and then the parameters and the coefficients of the filter are updated in a direction that reduces the optimization function, and the subset of terms and the subset of input samples for each term are determined based on the parameters and the coefficients that minimize the optimization function.

Another example, (e.g., example 19) relates to a previously described example (e.g., any one of examples 17-18), wherein the DPD adaptation circuitry is configured to perform regularization on the coefficients of the filter and remove one or more terms associated with a coefficient that becomes zero or below a predetermined threshold after regularization.

Another example, (e.g., example 20) relates to a machine-readable medium including code, when executed, to cause a machine to perform the method as in any one of examples 1-12.

Another example, (e.g., example 21) relates to a computer program having a program code for performing the method as in any one of examples 1-13, when the computer program is executed on a computer, a processor, or a programmable hardware component.

Another example, (e.g., example 22) relates to a machine-readable storage including machine readable instructions, when executed, to implement the method or realize the apparatus as in any one of examples 1-19.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for reducing complexity of a digital pre-distortion (DPD) model for a non-linear system, comprising:
receiving a block of input samples;
processing the block of input samples by DPD circuitry to generate a block of pre-distorted samples, wherein the DPD circuitry is configured to apply a pre-distortion function to the block of input samples to generate the block of pre-distorted samples, wherein the pre-distortion function is represented by a sum of a plurality of terms, and each term is a function of one or more input samples;
processing the block of pre-distorted samples by the non-linear system to generate a block of output samples;
performing an optimization process to determine a subset of the terms of the pre-distortion function and a subset of the input samples for each term of the pre-distortion function, wherein the optimization process is performed by solving an optimization function iteratively based on the block of input samples and the block of output samples to find parameters of the pre-distortion function that minimize the optimization function; and
configuring the DPD circuitry based on the determined subset of terms and the determined subset of input samples for each term.

2. The method of claim 1, wherein each term of the pre-distortion function is multiplied with a corresponding multiplier factor with a constraint that the terms have a unit norm.

3. The method of claim 2, wherein, at a beginning of the optimization process, the pre-distortion function is configured with an initial number of terms, and each term is configured with an initial set of input samples, and the multiplier factors are set to initial values, and the optimization process is performed iteratively.

4. The method of claim 3, wherein the optimization function is solved iteratively using a gradient descent algorithm wherein a gradient of the optimization function with respect to parameters of the pre-distortion function and the multiplier factors is calculated and then the parameters and the multiplier factors are updated in a direction that reduces the optimization function, and the subset of terms and the subset of input samples for each term are determined based on the parameters and the multiplier factors that minimize the optimization function.

5. The method of claim 4, further comprising performing regularization on the multiplier factors and removing one or more terms associated with a multiplier factor that becomes zero after regularization.

6. The method of claim 4, further comprising removing one or more terms associated with a multiplier factor that is lower than a predetermined threshold.

7. The method of claim 1, wherein the subset of input samples are selected for each term by filtering the input samples with a filter with a constraint that coefficients of the filter have a unit norm.

8. The method of claim 7, wherein, at a beginning of the optimization process, the pre-distortion function is configured with an initial number of terms, and each term is configured with an initial set of input samples, and coefficients of the filter are set to initial values, and the optimization process is performed iteratively.

9. The method of claim 8, wherein the optimization function is solved iteratively using a gradient descent algorithm wherein a gradient of the optimization function with respect to parameters of the pre-distortion function and the coefficients of the filter is calculated and then the parameters and the coefficients of the filter are updated in a direction that reduces the optimization function, and the subset of terms and the subset of input samples for each term are determined based on the parameters and the coefficients that minimize the optimization function.

10. The method of claim 8, further comprising performing regularization on the coefficients of the filter and removing one or more terms associated with a coefficient that becomes zero or below a predetermined threshold after regularization.

11. The method of claim 1, wherein the subset of input samples assigned to each term are two samples.

12. The method of claim 1, wherein each term of the pre-distortion function is multiplied with a corresponding multiplier factor with a constraint that the terms have a unit norm, and the subset of input samples are selected for each term by filtering the input samples with a filter with a constraint that coefficients of the filer have a unit norm,
wherein the optimization function is solved iteratively using a gradient descent algorithm wherein a gradient of the optimization function with respect to parameters of the pre-distortion function, the multiplier factors, and the coefficients of the filter is calculated and then the parameters, the multiplier factors, and the coefficients are updated in a direction that reduces the optimization function, and the subset of terms and the subset of input samples for each term are determined based on the parameters, the multiplier factors, and the coefficients that minimize the optimization function.

13. An apparatus for reducing complexity of a digital pre-distortion (DPD) model for a non-linear system, comprising:
DPD circuitry configured to receive input samples, and process the input samples to generate pre-distorted samples, wherein the DPD circuitry is configured to apply a pre-distortion function to the input samples to generate the pre-distorted samples, wherein the pre-distortion function is represented by a sum of a plurality of terms, and each term is a function of one or more input samples;
a non-linear system configured to process the pre-distorted samples to generate output samples; and
DPD adaptation circuitry configured to determine a subset of the terms of the pre-distortion function and a subset of the input samples for each term of the pre-distortion function and configure the DPD circuitry based on the determined subset of terms and the determined subset of input samples for each term, wherein the DPD adaptation circuitry is configured to solve an optimization function iteratively based on the input samples and the output samples to identify parameters of the pre-distortion function that minimize the optimization function.

14. The apparatus of claim 13, wherein each term of the pre-distortion function is multiplied with a corresponding multiplier factor with a constraint that the terms have a unit norm, wherein, at a beginning, the pre-distortion function is based on an initial number of terms, and each term is based on an initial set of input samples, and the multiplier factors are set to initial values.

15. The apparatus of claim 14, wherein the DPD adaptation circuitry is configured to solve the optimization function iteratively using a gradient descent algorithm wherein a gradient of the optimization function with respect to parameters of the pre-distortion function and the multiplier factors is calculated and then the parameters and the multiplier factors are updated in a direction that reduces the optimization function, and the subset of terms and the subset of input samples for each term are determined based on the parameters and the multiplier factors that minimize the optimization function.

16. The apparatus of claim 15, wherein the DPD adaptation circuitry is configured to perform regularization on the multiplier factors and remove one or more terms associated with a multiplier factor that becomes zero or below a predetermined threshold after regularization.

17. The apparatus of claim 13, wherein the DPD circuitry include a filter for selecting the subset of input samples for each term with a constraint that coefficients of the filter have a unit norm, wherein, at a beginning, the pre-distortion function is based on an initial number of terms, and each term is based on an initial set of input samples, and coefficients of the filter are set to initial values.

18. The apparatus of claim 17, wherein the DPD adaptation circuitry is configured to solve the optimization function iteratively using a gradient descent algorithm wherein a gradient of the optimization function with respect to parameters of the pre-distortion function and the coefficients of the filter is calculated and then the parameters and the coefficients of the filter are updated in a direction that reduces the optimization function, and the subset of terms and the subset of input samples for each term are determined based on the parameters and the coefficients that minimize the optimization function.

19. The apparatus of claim 17, wherein the DPD adaptation circuitry is configured to perform regularization on the coefficients of the filter and remove one or more terms associated with a coefficient that becomes zero or below a predetermined threshold after regularization.

20. A machine-readable medium including code, when executed, to cause a machine to perform a method of claim 1.
